(19) United States
(12) Patent Application Publication
(10) Pub. No.: US 2018/0328665 A1
(43) Pub. Date: Nov. 15, 2018

(54) SLAB REHEAT FURNACE SKID BUTTON AND METHOD TO REDUCE GOUGE OF STAINLESS STEEL SLABS

(71) Applicant: AK Steel Properties, Inc., West Chester, OH (US)

(72) Inventors: Ken Morales Higa, West Chester, OH (US); Jun Hu, Liberty Township, OH (US); Paul Chao-Peng Wu, Springboro, OH (US); Kavesary Raghavan, West Chester, OH (US)

(21) Appl. No.: 15/974,801

(22) Filed: May 9, 2018

Related U.S. Application Data
(60) Provisional application No. 62/503,689, filed on May 9, 2017.

(51) Int. Cl. F27D 3/02

(52) U.S. Cl. CPC F27D 3/024; F27D 2003/0059

(57) ABSTRACT

A skid rider button is provided for use in a steel reheating furnace to reduce gouge-type damage of a steel slab heated in the reheating furnace. The button includes a top surface defining an interface surface area to receive the steel slab to be reheated, a bottom surface couplable with a skid assembly of the reheating furnace, a front surface, a rear surface, and two opposing side surfaces positioned between the front surface and the rear surface. An overall height of the button between the bottom surface and the top surface may be reduced to lower the interface temperature of the button. The interface surface area may be increased to lower the interface temperature of the button. The button may include rounded edges between each of the surfaces to reduce the mechanical impact between the button and the steel slab.

### PRIORITY

This application claims priority to U.S. Provisional Application Ser. No. 62/503,689, entitled “Slab Reheat Furnace Skid Button and Method to Reduce Gouge of Stainless Steel Slabs,” filed on May 9, 2017, the disclosure of which is incorporated by reference herein.

### BACKGROUND

In steel making, a reheating furnace can be used to heat steel slabs, or other steel stock such as ingots, blooms, billets, etc., until the slab is sufficiently hot for further processing or reduction (e.g., rolling, forging, drawing, etc.) The heating process in a reheating furnace may be a continuous process where the steel slab is charged at the furnace entrance, heated in the furnace, and discharged at the furnace exit. In one continuous-type of reheating furnace, the steel slab is pushed through the furnace in an incremental or step-wise manner on steel beams or skids. Heat may be transferred to the steel slab during its traverse through the furnace on the skids by means of convection and/or radiation from burner gases and the furnace walls from above and/or below.

In some versions, the skids of the reheating furnace are constructed of water cooled pipe sections with one or more skid rider buttons positioned on a top surface of the skids. The skid rider buttons thereby prevent the hot material of the steel slab from directly contacting the water-cooled beams, which may locally restrict heat to the steel slab and cause a temperature differential that may be visually identifiable and adversely affect steel uniformity.

For instance, a typical skid assembly (50) is shown in FIGS. 1-2 comprising a steel skid (58) cooled with water (52) in an interior portion of the skid (58). The skid (58) further includes at least one mounting block (54) extending upward from a top surface of the skid (58). The mounting block (56) of the illustrated embodiment defines an opening (56) configured to receive a pin (70). A prior art skid rider button (60), shown in FIG. 1, is positioned on a mounting block (54) of the skid assembly (50) to receive a steel slab (2). As best seen in FIGS. 3-4, the skid rider button (60) comprises a top surface (62), a bottom surface (61), a front surface (64), a rear surface (68), and two opposing side surfaces (66). As shown, each of the side surfaces (66) extend upwardly from the bottom surface (61) and include a tapered portion (67) that tapers inwardly toward the top surface (62), which is configured to receive the steel slab (2). The bottom surface (61) of the button (60) comprises a recess (83) formed by a tapered wall (82) extending upwardly and inwardly to an interior wall (84) that extends upwardly to a lateral wall (86). A notch (88) is provided between the interior wall (84) and the lateral wall (86). An opening (80) then extends laterally through the button (60) between the opposing side surfaces (66) in the recess (83) portion. Accordingly, the button (60) is configured to be positioned on the skid assembly (50) such that the mounting block (54) is inserted within the recess (83) on the bottom surface (61) of the button (60). The pin (70) can then be inserted through the aligned openings (80, 56) of the button (60) and mounting block (54) to maintain the button (60) on the skid assembly (50).

The button (60) of the illustrated embodiment includes a height of about 135 mm, a width of about 70 mm, and a length of about 150 mm. The top surface (62) of the button (60) has a contact area of about 7,044 mm² for receiving a bottom surface of a steel slab (2). The button (60) further has angular edges between each of the top surface (62), the front surface (64), the rear surface (68), the bottom surface (61) and each of the side surfaces (66).

As a result of contacting such a skid rider button, a bottom surface of the steel slab may display gouge-type damage in some instances due to: 1) an undesired contact angle between the steel slab and the supporting skid rider button, and/or 2) excessive oxide build-up on the skid rider button. The contact angle may be indicative of mechanical contributions and the oxide build-up may suggest that a controlled thermal profile of the skid rider button is essential for reducing and/or preventing such gouge-type damage. Accordingly, there is a need to provide an improved skid rider button to reduce the severity of these gouge-type damages by modifying the geometry of the skid rider button.

### SUMMARY

An improved design of a skid rider button is therefore provided with smoother edges and/or corners, a reduced height, and/or an increased interface area. This design is based on simultaneous consideration of heat transfer needs and mechanical impact. Accordingly, the gouge-type damage caused by mechanical impact of the steel slab being placed on the skid rider button is reduced by the rounded corners, the rounded edges, and/or the increased interface area of the skid rider button. The gouge-type damage caused by thermal properties or heat transfer between the steel slab and the skid rider button is reduced by the reduced height and/or increased interface area of the skid rider button.

### DESCRIPTION OF FIGURES

It is believed that the present invention will be better understood from the following description of certain examples taken in conjunction with the accompanying drawings, in which like reference numerals identify like elements.

FIG. 1 depicts a perspective cross-sectional view of a prior art skid rider button positioned between a steel slab and a skid assembly of a steel reheating furnace.

FIG. 2 depicts a side elevational view of the skid assembly of FIG. 1.

FIG. 3 depicts a front view of the prior art skid rider button of FIG. 1.

FIG. 4 depicts a side elevational view of the prior art skid rider button of FIG. 1.

FIG. 5 depicts a perspective view of an improved skid rider button for use with the skid assembly of FIG. 1.

FIG. 6 depicts a front cross-sectional view of the skid rider button of FIG. 5.

FIG. 7 depicts a side elevational view of the skid rider button of FIG. 5.

FIG. 8 depicts a partial front cross-sectional view of the skid rider button of FIG. 5.

FIG. 9 depicts a perspective cross-sectional view of the skid rider button of FIG. 5 positioned on the skid assembly of FIG. 1.

FIG. 10 depicts a graph of the percentage of production slabs diverted for divots by grade.

FIG. 11A depicts a temperature distribution at a point of contact between an improved skid rider button and a steel slab.

FIG. 11B depicts a temperature distribution at a point of contact between the prior art skid rider button and a steel slab.

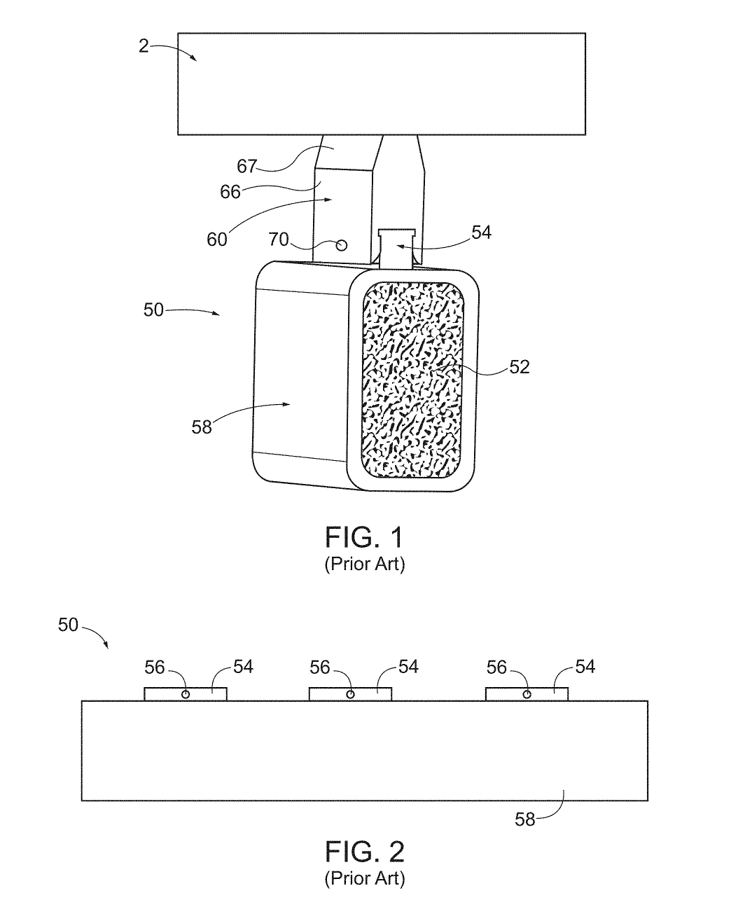

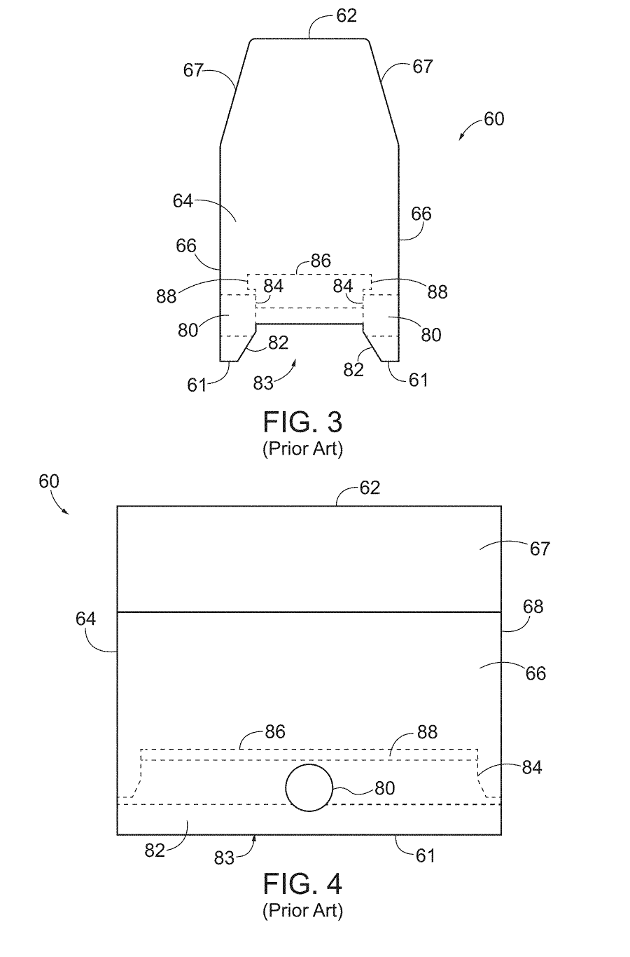

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification illustrate several aspects of the present disclosure, and together with the descriptions serve to explain the principles and concepts of the present disclosure; it being understood, however, that the present disclosure is not limited to the precise arrangements shown.

### DETAILED DESCRIPTION

The following description and embodiments of the present disclosure should not be used to limit the scope of the present disclosure. Other examples, features, aspects, embodiments, and advantages of the present disclosure will become apparent to those skilled in the art from the following description. As will be realized, the present disclosure may contemplate alternate embodiments than those exemplary embodiments specifically discussed herein without departing from the scope of the present disclosure. Accordingly, the drawings and descriptions should be regarded as illustrative in nature and not restrictive.

In a steel reheating furnace, such as a walking beam type reheating furnace or other type of continuous reheating furnace, skid rider buttons typically rest on water-cooled steel skids. During normal furnace operation, steel slabs to be reheated by the gas-fired environment typically rest on these buttons. The contact between the steel slab and the skid rider buttons may cause gouges or other damage to the surface of the steel slab in some instances. Such damage may be caused by a first form of gouge-type damage due to mechanical impact of the steel slab on angular corners or edges of the skid rider button at an undesirable contact angle. Additionally or alternatively, damage may be caused by a second form of gouge-type damage due to thermal properties caused by oxide build-up on an interface surface of the skid rider button.

Accordingly, it may be desirable to form a skid rider button with rounded corners, rounded edges, a reduced height, and/or an increased interface area. The first form of gouge-type damage caused by mechanical impact of the steel slab being placed on the skid rider button is thereby reduced by the rounded corners, the rounded edges, and/or the increased interface area of the skid rider button. The second form of gouge-type damage caused by thermal properties or heat transfer between the steel slab and the skid rider button is thereby reduced by the reduced height and/or increased interface area of the skid rider button. Such an improved design of a skid rider button is therefore provided based on simultaneous consideration of heat transfer needs and mechanical impact to provide a button free of angular corners with a low interface temperature.

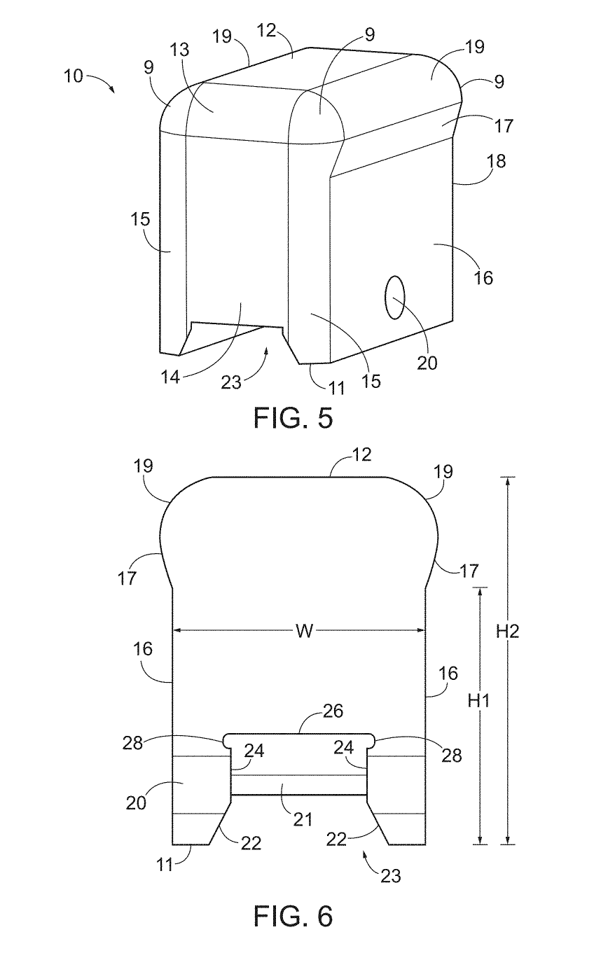

Referring to FIGS. 5-8, an improved skid rider button (10) is shown for use in a steel reheating furnace to support a steel slab to be reheated. The button (10) comprises a top surface (12), a bottom surface (11), a front surface (14), a rear surface (18), and two opposing side surfaces (16), as shown in FIG. 5. Accordingly, the bottom surface (11) of the button (10) is configured to rest on a steel skid assembly (50) of the reheating furnace, and the top surface (12) is configured as an interface surface to receive a steel slab to be reheated. The interface area is thereby the surface area in which the top surface (12) contacts the bottom surface of a steel slab (2). As best seen in FIG. 6, each side surface (16) extends upwardly from the bottom surface (11) of the button (10) such that the opposing side surfaces (16) are substantially parallel. The height (H1) of each side surface (16) may be about 80 mm and the width (W) between each side surface (16) may be about 80 mm, though other suitable dimensions can be used. An opening (20) may extend through a bottom portion of the button (10) at the side surfaces (16). A tapered wall (17) is then positioned at the top of each side surface (16) that extends upwardly and outwardly relative to the side surface (16). This tapered wall (17) may have a height of about 15 mm and extend outwardly between about 4 and about 19 mm. Of course, other suitable dimensions can be used. The tapered wall (17) thereby forms an overhang on each broad edge of the button (10). Because this overhang is not excessive along the side surfaces (16), the structural life of the button (10) may be improved.

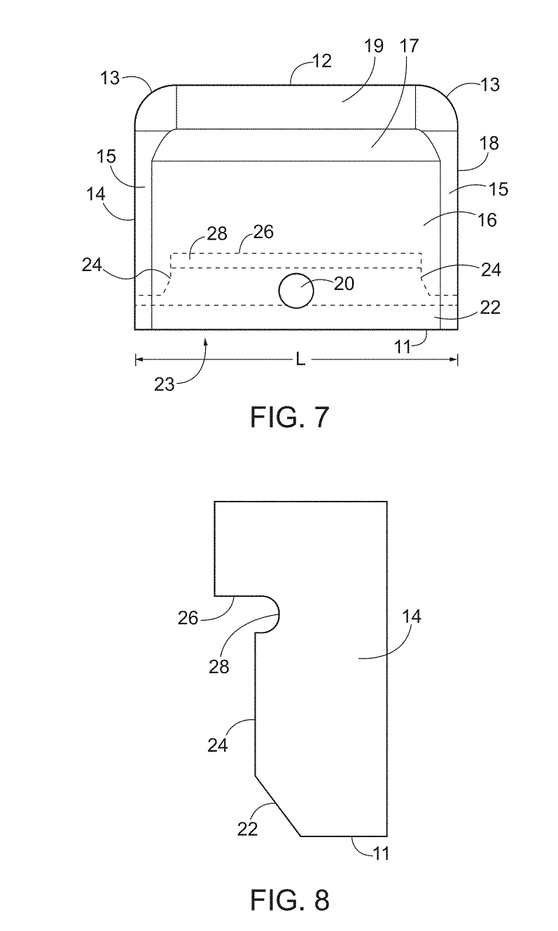

The button (10) further comprises a first rounded edge (19) extending between the top of each tapered wall (17) and the top surface (12). A rounded edge, such as the first rounded edge (19), may have a radius of greater than about 4 mm, such as between about 4 and about 40 mm, though other suitable dimensions can be used. The button (10) thereby may have an overall height (H2) of between about 115 and about 120 mm, but other suitable dimensions can be used. As best seen in FIG. 7, the length (L) of the button (10) between the front surface (14) and the rear surface (18) may be about 152.4 mm, but other suitable dimensions can be used. In some instances, the length (L) of the button (10) may be greater than about 152.4 mm, such as about 378 mm. This may provide the top surface (12) with an interface area of greater than about 7500 mm², such as between about 7500 and about 12000 mm², but other suitable dimensions can be used. A second rounded edge (13) is also provided between the top surface (12) and each of the front and rear surfaces (14, 18). The second rounded edge (13), may have a radius of greater than about 4 mm, such as between about 4 and about 40 mm, though other suitable dimensions can be used. In the illustrated embodiment, the front and rear surfaces (14, 18) extend upwardly substantially parallel with each other to each second rounded edge (13) such than an overhang is not provided at the second rounded edges (13). A rounded corner (9) may thereby be provided between the first and second rounded edges (19, 13) to transition from the side portion with an overhang to the front and rear portions without an overhang, as shown in FIG. 5. A third rounded edge (15) may also be provided between the front and rear surfaces (14, 18) and each side surface (16). The third rounded edge (15), may have a radius of greater than about 4 mm, such as between about 4 and about 40 mm, though other suitable dimensions can be used. The button (10) may be made from high-chromium nickel and/or cobalt based superalloys. Of course, other suitable configurations for the button (10) will be apparent to one with ordinary skill in the art in view of the teachings herein.

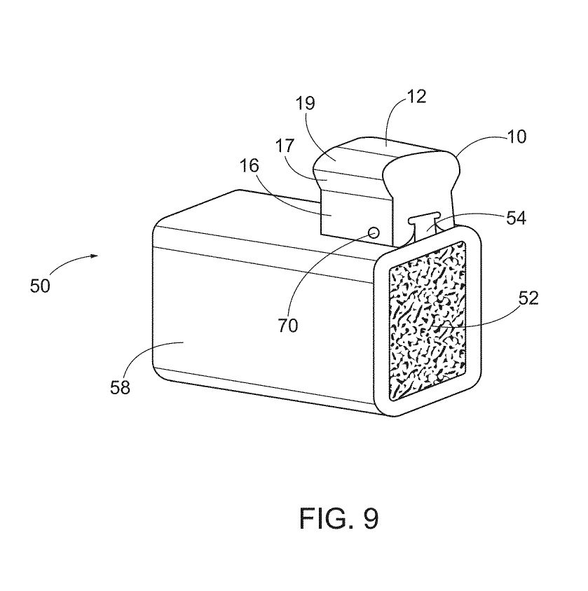

Referring to FIGS. 6 and 8, the bottom surface (11) of the button (10) comprises recess (23) extending inwardly from the bottom surface (11). The recess (23) is formed by a tapered wall (22) extending upwardly and inwardly to an interior wall (24) that extends upwardly to a lateral wall (26). A fillet (28) is provided between the interior wall (24) and the lateral wall (26). The fillet (28) may have a radius of about 2 mm, but other suitable dimensions can be used. Accordingly, the button (10) may be positioned on the skid assembly (50), as shown in FIG. 9, such that the mounting block (54) is inserted within the recess (23) of the button (10) until the top surface of the mounting block (54) abuts the lateral wall (26) of the recess (23). The interior walls (24) of the recess (23) may align with side walls of the mounting block (54) and tapered walls (22, 21) may help to align the button (10) with the mounting block (54). The pin (70) may then be inserted within the aligned openings (20, 56) of the button (10) and the mounting block (54) to maintain the position of the button (10) relative to the skid assembly (50). Still other suitable configurations for coupling the button (10) with a skid assembly (50) will be apparent to one with ordinary skill in the art in view of the teachings herein.

The bottom surface (11) of the button (10) thereby rests on the skid assembly (50) of the reheating furnace. A bottom surface of the steel slab (2) is also supported by the top surface (12) of the button (10) on the interface area. Accordingly, each of the edges (19, 13, 15) and corners (9) of the button are smoothed to reduce and/or prevent gouges or divots in the exterior surface of the steel slab when the steel slab comes into contact with the button (10). Further, the reduced overall button height (H2) and/or increased interface area at the top surface (12) of the button (10) provides control to reduce the interface temperature between the steel slab and the button (10), to thereby reduce and/or prevent oxide build-up on the button (10). This reduction and/or prevention of oxide build-up may therefore reduce and/or prevent gouges or divots in the exterior surface of the steel slab from contact with the button (10).

### EXAMPLES

In one embodiment, a skid rider button for use in a steel reheating furnace may comprise a top surface configured as an interface surface to receive a steel slab to be reheated, a bottom surface couplable with a skid assembly of the reheating furnace, a front surface, a rear surface, and two opposing side surfaces positioned between the front surface and the rear surface. The button may be configured to reduce gouge-type damage to a surface of the steel slab when it is received on the interface surface of the button. For instance, the button may comprise at least one rounded edge configured to reduce gouge-type damage due to mechanical impact when the steel slab is received on the interface surface of the button. The at least one rounded edge may be provided between the top surface and each side surface and may have a radius of between about 4 millimeters and about 40 millimeters. The button may further comprise a tapered wall extending upwardly and outwardly between each side surface and the top surface to form a lateral overhang. The lateral overhang may be between about 4 millimeters and about 19 millimeters. The button may further comprise at least one rounded corner between the lateral overhang on each side surface and the front and rear surfaces. A rounded edge may also be provided between the top surface and the front and rear surfaces and/or between each of the side surfaces and the front and rear surfaces. The top surface of the button may comprise an increased interface area of between about 7500 millimeters and about 12000 millimeters such that the button is configured to disperse the impact pressure of the steel slab being placed on the button across the increased interface area.

The button may be configured to reduce gouge-type damage due to thermal properties when the steel slab is received on the interface surface of the button. The button may be configured to lower the interface temperature of the button to thereby prevent oxide build-up on the button. For example, the button may have a reduced overall height and an increased surface area. The button may comprise a maximum overall height between the bottom and top surfaces of about 120 millimeters. The top surface of the button may comprise an interface area of between about 7500 millimeters and about 12000 millimeters. The button may comprise a length between the front and rear surfaces of about 150 millimeters. The button may comprise a width between the opposing side surfaces of about 80 millimeters.

In another embodiment, a skid rider button for use in a steel reheating furnace may comprise a top surface defining an interface surface area to receive a steel slab to be reheated, a bottom surface couplable with a skid assembly of the reheating furnace, a front surface, a rear surface, and two opposing side surfaces positioned between the front surface and the rear surface. An overall height of the button between the bottom surface and the top surface may be sufficiently small enough to lower the interface temperature of the button. The interface surface area may be sufficiently large enough to lower the interface temperature of the button. The button may comprise rounded edges between each of the top surface, the front surface, the rear surface, and the two opposing side surfaces. The button may further comprise a tapered wall extending upwardly and outwardly between each side surface and the top surface to form a lateral overhang. The button may comprise at least one rounded corner provided between the lateral overhang on each side surface and the front and rear surfaces. The bottom surface of the button may comprise a recess for receiving a mounting block of a skid assembly to couple the button with the skid assembly. A pin may be insertable through an opening of the button and an opening of the mounting block to maintain the position of the button relative to the mounting block.

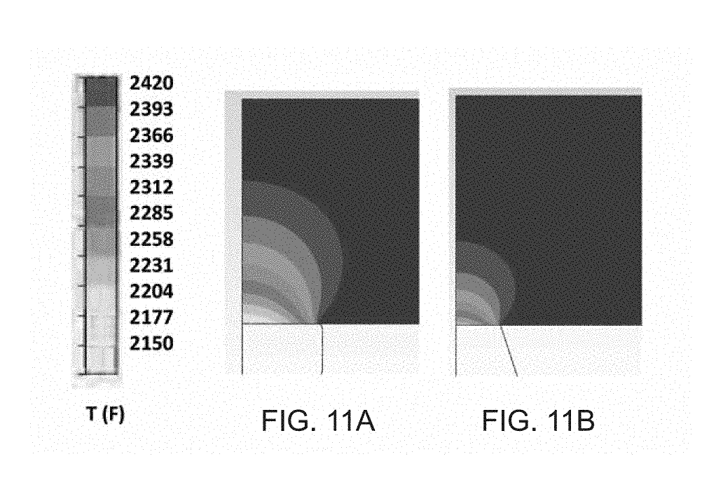

Experimental results suggested that high temperature interaction between oxide layers from both the steel slab and the skid rider button contributed to the formation of oxide buildup. Computational heat transfer modeling results suggested that the interface temperature between the skid rider button and the slab can be reduced by decreasing button height and/or increasing the interface area. Referring to FIGS. 11A and 11B, the temperature at the point of contact between the skid rider button and the steel slab was reduced with the improved skid rider button design. For instance, FIG. 11A shows the temperature distribution for an improved skid rider button having a contact interface area of about 24 in² and a height of about 3.9 inches. As shown, the temperature at the point of contact of the improved skid rider button is reduced compared to the temperature at the point of contact of the prior art skid rider button, shown in FIG. 11B, having a contact interface area of about 11 in² and a height of about 3.9 inches.

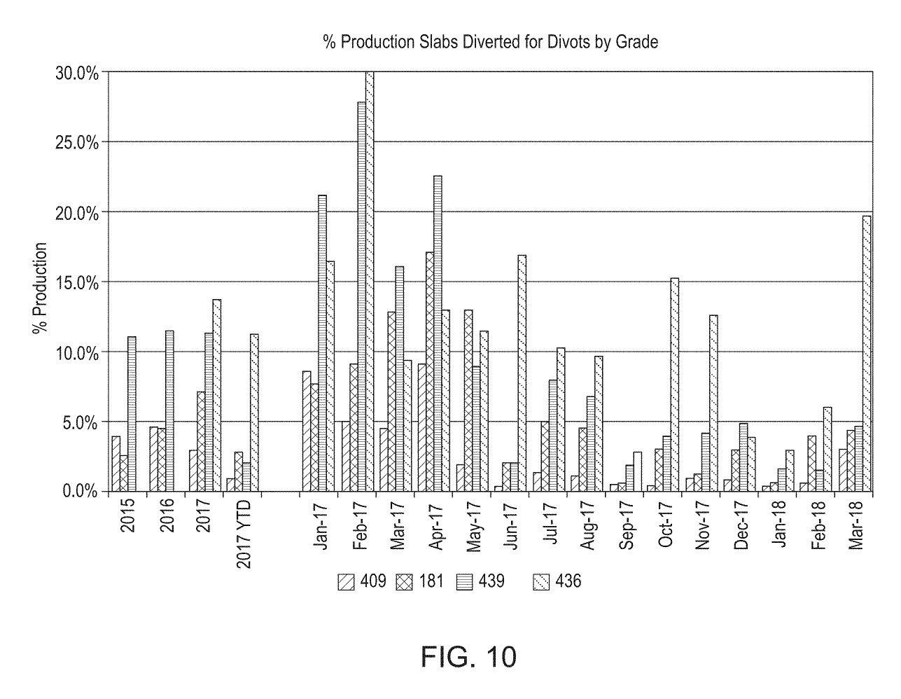

Rider buttons with enlarged interface areas were installed in a slab reheating furnace. Divot defects were present on the first few coils after the furnace restart, in areas associated with the beam, which suggested other additional mechanisms are partly responsible for the gouge-type damage. Computational impact-modeling results suggested that button-to-slab during contact, at less-than-desirable angles, could also produce gouge-type defect with similar dimensions to that caused by oxide build-up. Numerical modeling showed the indentation provided by the impact of the slab on the rider is reduced with a radius above about 10 to about 20 mm. Further, as can be seen in FIG. 10, the percentage of production slabs that were diverted for divots was reduced after the improved skid rider button was installed in September 2017.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A skid rider button for use in a steel reheating furnace, wherein the button comprises:
a top surface configured as an interface surface to receive a steel slab to be reheated;
a bottom surface couplable with a skid assembly of the reheating furnace;
a front surface;
a rear surface; and
two opposing side surfaces positioned between the front surface and the rear surface;
wherein the button comprises at least one rounded edge configured to reduce gouge-type damage due to mechanical impact when the steel slab is received on the interface surface of the button.

2. The button of claim 1, wherein the at least one rounded edge is provided between the top surface and each side surface.

3. The button of claim 2, wherein the at least one rounded edge has a radius of between about 4 millimeters and about 40 millimeters.

4. The button of claim 1, wherein the button further comprises a tapered wall extending upwardly and outwardly between each side surface and the top surface to form a lateral overhang.

5. The button of claim 4, wherein the lateral overhang is between about 4 millimeters and about 19 millimeters.

6. The button of claim 4 further comprising at least one rounded corner provided between the lateral overhang on each side surface and the front and rear surfaces.

7. The button of claim 1, wherein the at least one rounded edge is provided between the top surface and the front and rear surfaces.

8. The button of claim 1, wherein the at least one rounded edge is provided between each of the side surfaces and the front and rear surfaces.

9. The button of claim 1, wherein the top surface of the button comprises an interface area of between about 7500 millimeters and about 12000 millimeters.

10. A skid rider button for use in a steel reheating furnace, wherein the button comprises:
a top surface configured as an interface surface to receive a steel slab to be reheated;
a bottom surface couplable with a skid assembly of the reheating furnace;
a front surface;
a rear surface; and
two opposing side surfaces positioned between the front surface and the rear surface;
wherein the button is configured to lower the interface temperature of the button to thereby reduce oxide build-up on the top surface of the button to reduce gouge-type damage due to thermal properties when the steel slab is received on the interface surface of the button.

11. The button of claim 10, wherein the button comprises a maximum overall height between the bottom and top surfaces of about 120 millimeters.

12. The button of claim 10, wherein the top surface of the button comprises an interface area of between about 7500 millimeters and about 12000 millimeters.

13. The button of claim 10, wherein the button comprises a length between the front and rear surfaces of about 150 millimeters.

14. The button of claim 10, wherein the button comprises a width between the opposing side surfaces of about 80 millimeters.

15. The button of claim 10, wherein the button further comprises a tapered wall extending upwardly and outwardly between each side surface and the top surface to form a lateral overhang, wherein the lateral overhang is between about 4 millimeters and about 19 millimeters.

16. A skid rider button for use in a steel reheating furnace, wherein the button comprises:
a top surface defining an interface surface area to receive a steel slab to be reheated;
a bottom surface couplable with a skid assembly of the reheating furnace;
a front surface;
a rear surface; and
two opposing side surfaces positioned between the front surface and the rear surface;
wherein an overall height of the button between the bottom surface and the top surface is sufficiently small enough to lower the interface temperature of the button;
wherein the interface surface area is sufficiently large enough to lower the interface temperature of the button; and
wherein the button comprises rounded edges between each of the top surface, the front surface, the rear surface, and the two opposing side surfaces.

17. The button of claim 16, wherein the button further comprises a tapered wall extending upwardly and outwardly between each side surface and the top surface to form a lateral overhang.

18. The button of claim 17 further comprising at least one rounded corner provided between the lateral overhang on each side surface and the front and rear surfaces.

19. The button of claim 16, wherein the bottom surface of the button comprises a recess for receiving a mounting block of a skid assembly to couple the button with the skid assembly.

20. The button of claim 19 further comprising a pin insertable through an opening of the button and an opening of the mounting block to maintain the position of the button relative to the mounting block.
